(19) United States
(12) Patent Application Publication
(10) Pub. No.: US 2015/0273494 A1
(43) Pub. Date: Oct. 1, 2015

(54) SPRAY TIP ASSEMBLY FOR ELECTROSTATIC SPRAY GUN

(71) Applicant: GRACO MINNESOTA, INC., Minneapolis, MN (US)

(72) Inventors: David W. Koehne, Blaine, MN (US); Mark E. Ulrich, Oak Grove, MN (US); Tamara M. Bentley, Minneapolis, MN (US); Joseph A. Daniski, Minnetonka, MN (US)

(73) Assignee: Graco Minnesota Inc.

(21) Appl. No.: 14/432,673

(22) PCT Filed: Sep. 30, 2013
(86) PCT No.: PCT/US2013/062682

§ 371 Date: Mar. 31, 2015

Related U.S. Application Data
(60) Provisional application No. 61/708,153, filed on Oct. 1, 2012.

(51) Int. Cl. B05B 5/025; B05B 5/03

(52) U.S. Cl. CPC B05B 5/025; B05B 5/03

(57) ABSTRACT

An electrostatic spray gun comprises a gun barrel, a gun handle affixed to the gun barrel, and a spray tip assembly affixed to the gun barrel. The spray tip assembly comprises a tip assembly face, a tip disposed at the tip assembly face, an electrode extending perpendicularly from the tip assembly face, and a shield tower extending perpendicularly from the tip assembly face, and disposed cylindrically about the electrode.

### BACKGROUND

The present invention relates generally to applicators that are used to spray fluids, such as paint, sealants, coatings, enamels, adhesives, powders and the like. More particularly, the invention relates to electrostatic spray guns.

In electrostatic spray systems, an electrostatic field is produced in the vicinity between the spray gun and the target or article to be sprayed. The sprayed particles are propagated through this field, and the respective particles pick up electrical charges as they pass through the field. The charged particles are thereby attracted to the article to be sprayed. By this process, it is possible to direct a much higher percentage of sprayed particles to the actual article to be sprayed, and thereby the efficiency of spraying is vastly improved over conventional methods. Electrostatic spray guns are particularly useful for applying non-conductive liquids and powders, although they may be used in connection with spraying conductive liquids.

In a typical electrostatic spraying system, an ionizing electrode is placed in the vicinity of the spray gun spray orifice, the article to be painted is held at ground potential, and an electrostatic field is developed between the ionizing electrode and the article. The distance between the electrode and ground may be on the order of about 0.5 meters or less; therefore, the voltage applied to the spray gun electrode must necessarily be quite high in order to develop an electrostatic field of sufficient intensity to create a large number of ion/particle interactions so as to develop a sufficient attractive force between the paint particles and the target. It is not unusual to apply electrostatic voltages on the order of 20,000-100,000 volts (20-100 kV) to the spray gun electrode in order to achieve a proper degree of efficiency in the spraying operation. An ionizing current on the order of 50 micro-amps typically flows from the spray gun electrode.

Electrostatic spray guns may be hand-held spray guns or automatic spray guns operable by remote control connections. The sprayed fluid may be atomized using different primary atomizing forces, such as pressurized air, hydraulic forces, or centrifugal forces. Power for the electrostatic voltage may be generated in a variety of ways. In many systems, an external power source is connected to the electrostatic spray gun. However, in other designs, power may be generated with an alternator located in the electrostatic spray gun. For example, U.S. Pat. Nos. 4,554,622, 4,462,061, 4,290,091, 4,377,838, 4,491,276 and 7,226,004 describe electrostatic spray guns having an air-powered turbine which drives an alternator that in turn supplies a voltage multiplier to provide the charging voltage.

### SUMMARY

An electrostatic spray gun comprises a gun barrel, a gun handle affixed to the gun barrel, and a spray tip assembly affixed to the gun barrel. The spray tip assembly comprises a tip assembly face, a tip disposed at the tip assembly face, an electrode extending perpendicularly from the tip assembly face, and a shield tower extending perpendicularly from the tip assembly face, and disposed cylindrically about the electrode

### BRIEF DESCRIPTION OF THE DRAWINGS

FIG. 1 is a schematic of an electrostatic spray system showing an electrostatic spray gun connected to a fluid supply and discharging onto a target.

FIG. 2 is a perspective view of the electrostatic spray gun of FIG. 1 showing a gun barrel connected to a handle body and a spray tip assembly.

FIG. 3 is an exploded view of the electrostatic spray gun of FIG. 2 showing an alternator and a power supply configured to be located within the gun barrel.

FIG. 4 is a perspective view of the spray tip assembly of FIG. 2, showing a shield tower and a fluid orifice.

FIG. 5 is an exploded view of the spray tip assembly of FIG. 4.

FIG. 6 is a head-on view of the spray tip assembly of FIG. 5, showing angular locations of shield flanges and the shield tower relative to the fluid orifice.

### DETAILED DESCRIPTION

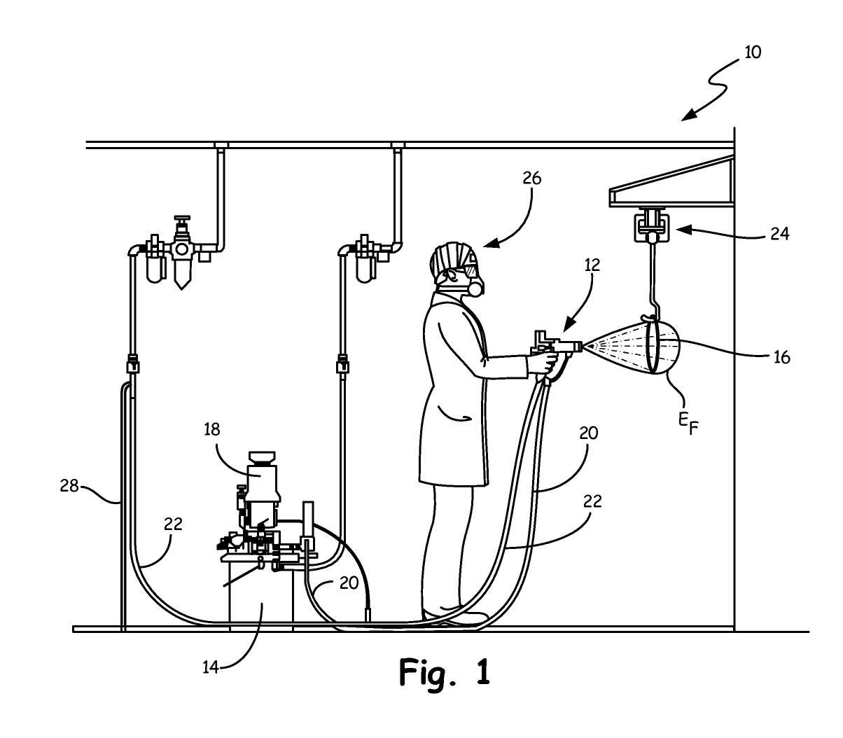

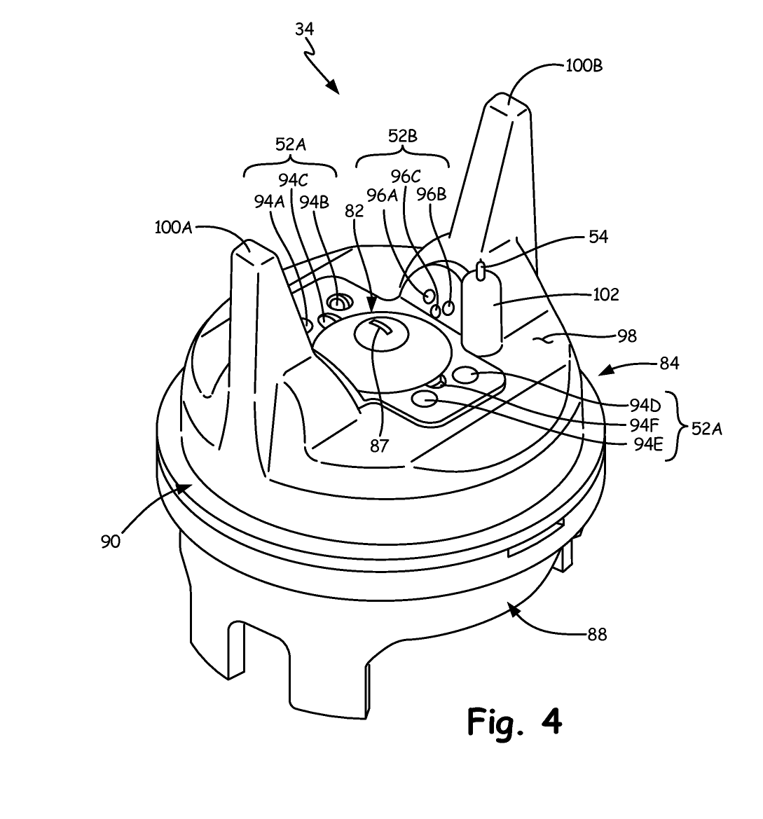

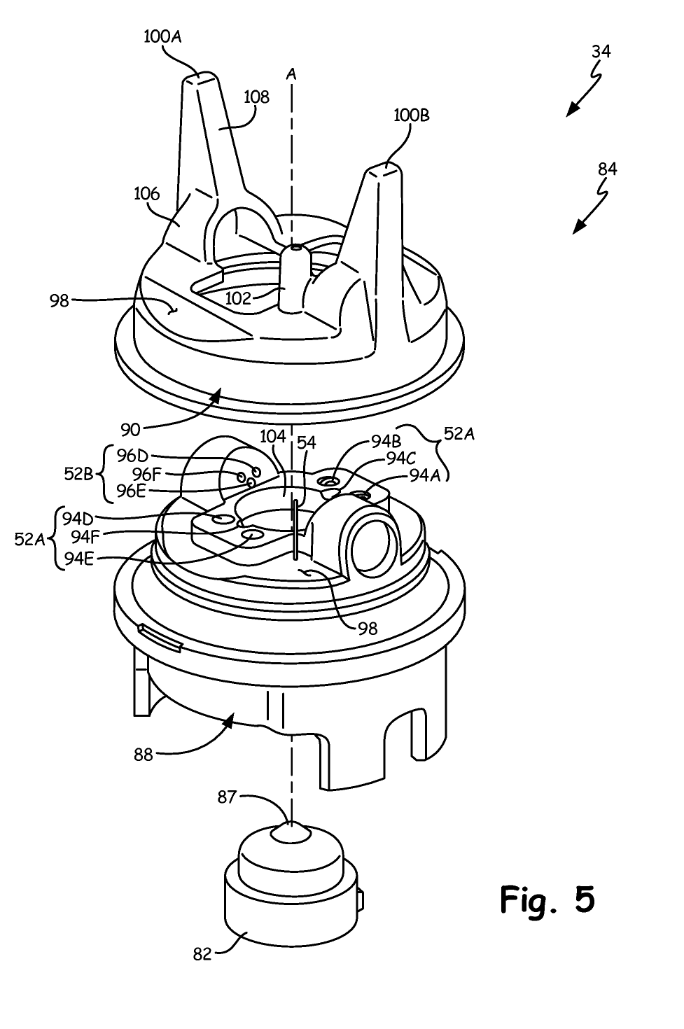

In embodiments of the present invention, an electrostatic spray gun includes a spray tip assembly with a raised tip, a single asymmetrically disposed electrode, and a shield tower that surrounds all but a distal end of the electrode. FIGS. 1-3 of the present disclosure describe an electrostatic spray gun in which a spray tip assembly may be used. FIGS. 4A-5B describe various aspects, embodiments and benefits of the spray tip assembly.

FIG. 1 is a schematic of electrostatic spray system 10 showing electrostatic spray gun 12 connected to fluid supply 14 and discharging onto target 16. Pump 18 is coupled to fluid supply 14 and provides pressurized fluid to spray gun 12 via hose 20. Spray gun 12 is also connected to a source of pressurized air (not shown) via hose 22. Target 16 is connected to ground, such as by being suspended from rack 24. Electrostatic spray system 10 is described with reference to a fluid spraying system, but other coating materials may be used with the present invention, such as powders and the like. Although FIGS. 1-3 are described with specific reference to an air-assist system, the present invention may also be used with an air-spray system.

Operator 26 positions spray gun 12 in close proximity to target 16, approximately 0.5 meters or less. Upon actuation of a trigger on spray gun 12, pressurized air is supplied to a turbine within spray gun 12 that powers an alternator to generate electrical power. The electrical power is supplied to an electrode near the spray tip of spray gun 12. Thus, electrical field EF is produced between the electrode and target 16. Electrostatic spray system 10 is grounded at various points. For example, ground wire 28 and/or conductive air hose 22 may ground spray gun 12. Other grounding wires and conductive materials may be used throughout electrostatic spray system 10 to provide grounding. Simultaneously, actuation of the trigger allows pressurized fluid from pump 18 through the spray tip whereby atomized particles of the fluid become charged in electrical field EF. The charged particles are thus drawn to target 16, which is grounded. Target 16 is suspended via rack 24 and the electrically charged fluid particles wrap around target 16, thereby significantly reducing overspray.

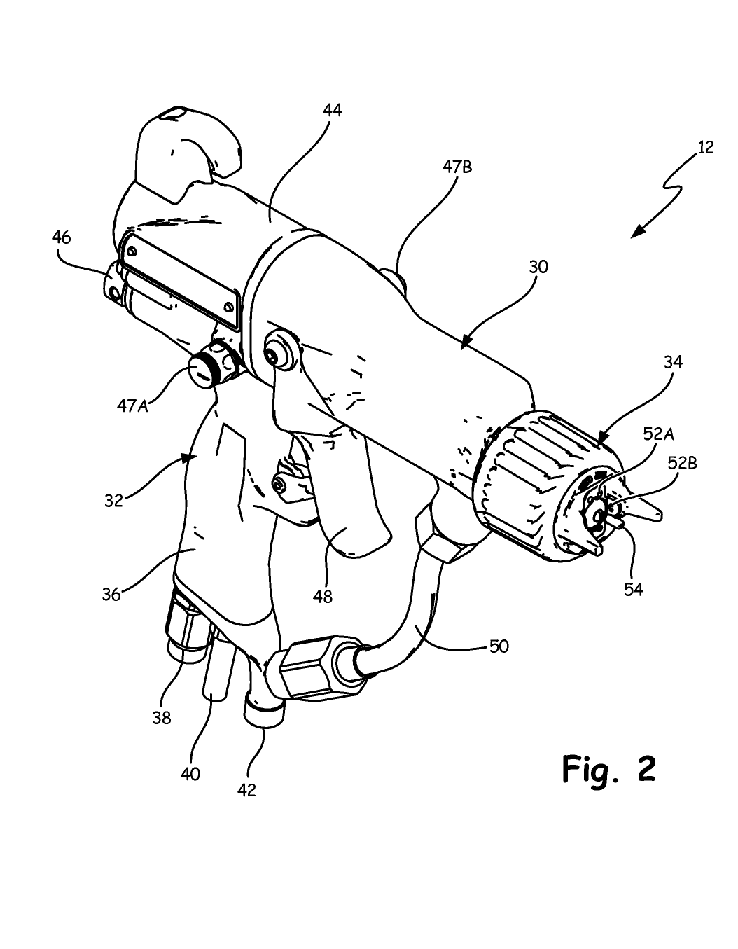

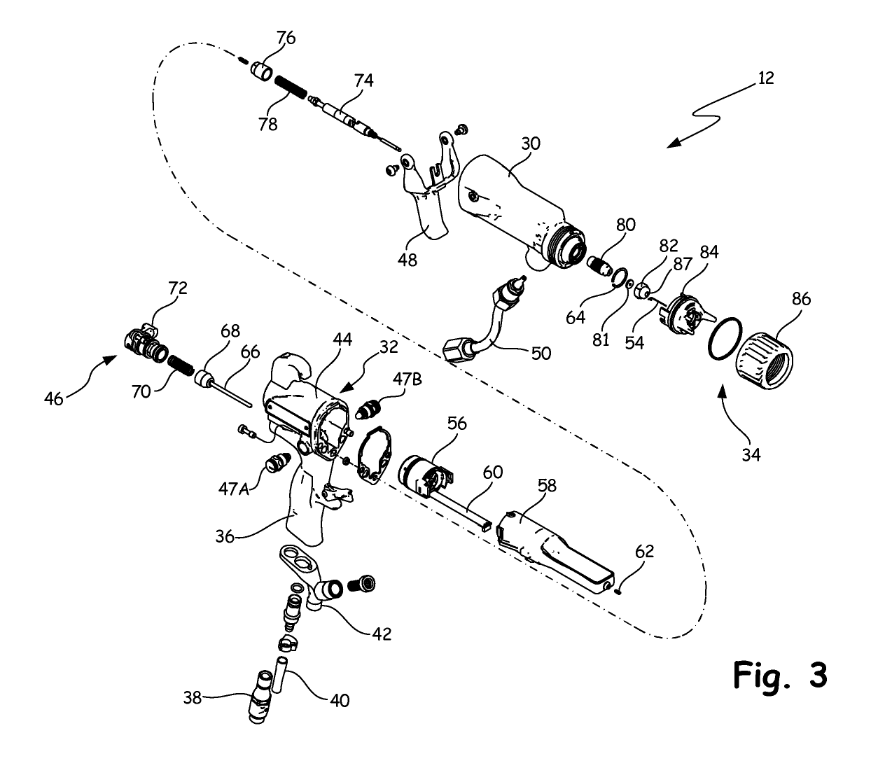

FIG. 2 is a perspective view of electrostatic spray gun 12 of FIG. 1 showing gun barrel 30 connected to handle body 32 and spray tip assembly 34. Handle 36 of handle body 32 is connected to air inlet 38, air exhaust 40 and fluid inlet 42. Housing 44 of handle body 32 is connected to gun barrel 30. Air control 46 is connected to an on/off valve (see air needle 66 in FIG. 3) within housing 44 and controls flow of compressed air from air inlet 38 to the components of spray gun 12. Air adjusters 47A and 47B control the flow of air from the aforementioned on/off valve to spray tip assembly 34. Trigger 48 is connected to a fluid valve (see fluid needle 74 in FIG. 3) within gun barrel 30 and is configured to control flow of pressurized fluid from fluid inlet 42 through spray tip assembly 34 via fluid tube 50. Air control 46 controls the flow of air to the alternator. The air then exits spray gun 12 at exhaust 40.

Actuation of trigger 48 simultaneously allows compressed air and pressurized fluid to spray tip assembly 34. Some of the compressed air is used to influence the flow of fluid from spray tip assembly 34 and thereby exits spray gun 12 at ports 52A and 52B, or other such ports. In air-spray systems, some of the compressed air is also used to directly atomize the fluid as it exits the spray orifice. In both air-spray and air-assist systems, some of the compressed air is also used to rotate an alternator that provides power to electrode 54 and leaves spray gun 12 at exhaust 40. The alternator and an associated power supply for electrode 54 are shown in FIG. 3.

FIG. 3 is an exploded view of electrostatic spray gun 12 of FIG. 2 showing alternator 56 and power supply 58 configured to be located within handle body 32 and gun barrel 30. Alternator 56 is connected to power supply 58 via ribbon cable 60. Alternator 56 couples to power supply 58 and, when assembled, alternator 56 fits into housing 44 and power supply 58 fits into gun barrel 30. Electricity generated by alternator 56 is transmitted to power supply 58. In air-assist systems, an electric circuit, including spring 62 and conductive ring 64, conveys the electric charge from power supply 58 to electrode 54 inside of spray tip assembly 34. Air-spray systems may have other electric circuits connecting the alternator to the electrode.

Air needle 66 and seal 68 comprise an on/off valve for control of compressed air through spray gun 12. Air control valve 46 includes air needle 66 that extends through housing 44 to trigger 48, which can be actuated to move seal 68 and control flow of compressed air from air inlet 38 through passages within handle body 32. Spring 70 biases seal 68 and trigger 48 to a closed position, while knob 72 may be adjusted to manipulate valve 46. With seal 68 opened, air from inlet 38 flows through the passages within handle body 32 to alternator 56 or spray tip assembly 34.

Fluid needle 74 comprises part of a fluid valve for control of pressurized fluid through spray gun 12. Actuation of trigger 48 also directly moves fluid needle 74, which is coupled to trigger 48 via cap 76. Spring 78 is positioned between cap 76 and trigger 48 to bias needle 74 to a closed position. Needle 74 extends through gun barrel 30 to spray tip assembly 34.

Spray tip assembly 34 includes seat housing 80, gasket 81, tip 82, air cap 84 and retainer ring 86. In air-assist systems, fluid needle 74 engages seat housing 80 to control flow of pressurized fluid from fluid tube 50 through to spray tip assembly 34. Gasket 81 seals between seat housing 80 and tip 82. Tip 82 includes spray orifice 87 that discharges pressurized fluid from seat housing 80. Electrode 54 extends from air cap 84. In air-assist systems, high pressure fluid is fed through spray orifice 87, from which electrode 54 is offset. Atomization occurs by passing the high pressure fluid through a small orifice. In air-spray systems, an electrode extends from a spray orifice such that the electrode and spray orifice are concentric. Low pressure fluid passes through a large spray orifice, and is atomized by impinging airflow from air cap 34. In either systems, air cap 84 includes ports, such as ports 52A and 52B (FIG. 2), that receive pressurized air to atomize and shape the flow of fluid from tip 82 based on setting of adjusters 47A and 47B. In other embodiments, gun 12 may operate without either of ports 52A and 52B, or may operate with only one of ports 52A and 52B.

Operation of alternator 56 under force of pressurized air provides electrical energy to power supply 58 that in turn applies a voltage to electrode 54. Electrode 54 generates electrical field EF (FIG. 1) that applies a charge to atomized fluid originating from tip 82. The Corona effect produced by electrical field EF carries the charged fluid particles to the target intended to be coated with the fluid. Retainer ring 86 maintains air cap 84 and tip 82 assembled with gun barrel 30, while seat housing 80 is threaded into gun barrel 30.

FIG. 4 is a perspective view of spray tip assembly 34, illustrating ports 52A (comprising air passages 94A-94F) and 52B (comprising air passages 96A-96C and 96D-96F, not shown), electrode 54, tip 82 (with fluid orifice 87), air cap 84 (comprising base piece 88 and shield piece 90). Base piece 88 and shield piece 90 together define tip assembly face 98, a substantially flat plane surrounding tip 82. Shield piece 90 further comprises shield flanges 100A and 100B, and shield tower 102.

FIG. 5 is an exploded view of spray tip assembly 34, illustrating electrode 54, spray tip 82 (with fluid orifice 87), base piece 88 (with port 52A comprising air channels 94A-94F, port 52B comprising air channels 96A-96F, and central aperture 104), and shield piece 90 (with shield flanges 100A and 100B, and shield tower 102). Base piece 88 and shield piece 90 together make up air cap 84. Tip assembly face 98 extends across both base piece 88 and shield piece 90. Tip 82, base piece 88, and shield piece 90 are aligned along a common axis A. Central aperture 104 is a hollow space in base piece 88 through which tip 82 fits during assembly, such that base piece 88 is fits over tip 82 and tip 82 fits into central aperture 104 to retain tip 82 on gasket 81. Electrode 54 extends through base piece 88 parallel to axis A. Shield piece 90 fits over base piece 88 such that shield tower 102 surrounds all but an axially outermost tip of electrode 54. In some embodiments, tip 82, base piece 88, and shield piece 90 may engage one another in a snap fit. In other embodiments, tip 82, base piece 88, and shield piece 90 may be retained together in spray tip assembly 34 via clamping by retainer ring 86. In the depicted embodiment, shield flanges 100A and 100B have broad bases 106 near tip assembly face 98 to house air channels 96A-96F of port 52B, and wedge sections 108 angled away from tip 82 and extending outward from tip assembly face 98.

In the embodiment depicted in FIGS. 4 and 5, base piece 88 retains tip 82 on gasket 81 (see FIG. 3), while base piece 88 and shield piece 90 are in turn retained on gun barrel 30 by retainer ring 86. Gun barrel 30 (FIG. 3) is a rigid, non-conductive piece that may, for instance, be formed of plastic. Tip 82, base piece 88, and shield piece 90 are mating components that are separable by hand and/or with a handheld pry tool. Base piece 88 may, for example, be formed of a rigid, nonconductive material such as a hard synthetic polymer. Shield piece 90 may be formed of a less rigid, nonconductive material such as rubber or another slightly deformable or compressible polymer. Tip 82 may be formed of a nonconductive material such ceramic, a rigid polymer, or other high durability materials, or may be a composite of a body material surrounding a higher-strength piece that defines fluid orifice 87. Fluid orifice 87 can be a pinpoint aperture, or a shaped aperture that directs fluid spray in a suitable pattern.

As described above with respect to FIG. 3, ports 52A and 52B direct air across and in front of tip 82. Airflow from ports 52A and 52B impinges on pressurized fluid from seat housing 80 exiting tip 82 via fluid orifice 87 to help atomize and shape spray pattern.

In the depicted embodiment, port 52A comprises six air channels 94A-94F through base piece 88. Air channels 94A-94F are air outlets, as described above with respect to FIGS. 2 and 3. Air channels 94A-94C are situated opposite tip 82 from air channels 94D-94F. Air channels 94A-94F may, for instance, be oriented to direct impinging airflow on fluid from fluid orifice 87 at a variety of angles for improved fluid shaping and/or atomization. Although the depicted embodiment shows six distinct air channels, embodiments with more or fewer channels are also possible.

Port 52B comprises air channels 96A-96C through base piece 88. Like air channels 94A-94F, air channels 96A-96F are air outlets. Air channels 96D-96F can be seen in FIG. 5, but are obscured in FIG. 4 by shield flange 100A. Air channels 96A-96C are situated at the base of shield flange 100B, while air channels 96D-96F are situated at the base of shield flange 100A. Like air channels 94A-94F, air channels 96A-96F may be oriented to direct impinging airflow on fluid from fluid orifice 87 at a variety of angles for improved fluid shaping and/or atomization. In the depicted embodiment, ports 52A shape the spray pattern, while ports 52B atomize fluid. In other embodiments, the roles of ports 52A and 52B may be switched, and/or any combination of ports 52A and 52B may perfom shaping and/or atomization roles.

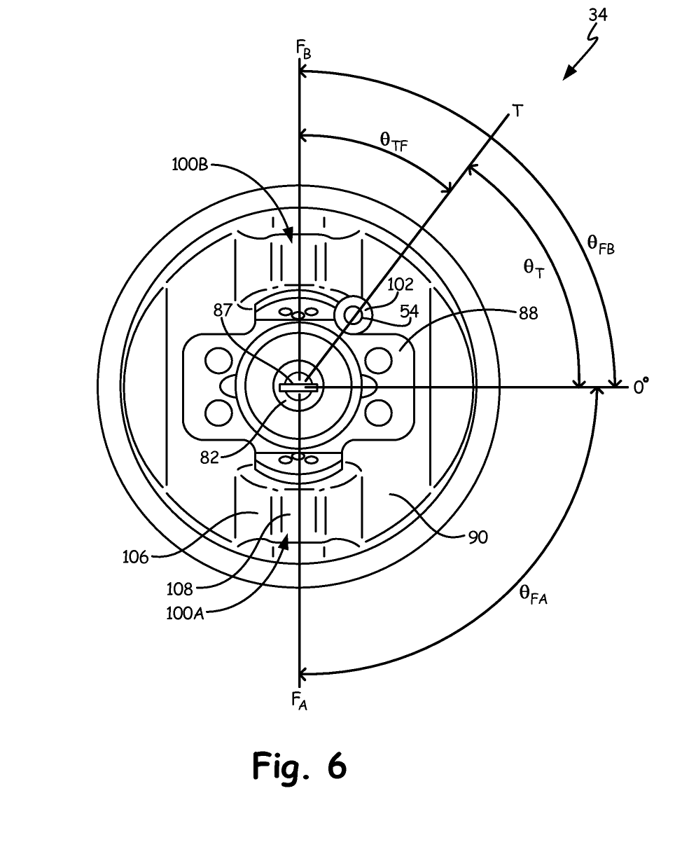

Tip 82 supports fluid orifice 87 on a convex surface, such that fluid orifice 87 is raised relative to tip assembly face 98. Raising tip 82 relative to tip assembly face 98 allows for improved fluid control and reduces fouling relative to a recessed tip. Shield piece 90 includes shield flanges 100A and 100B, and shield tower 102. Shield flanges 100A and 100B extend outward from tip assembly face 98 for operator safety. In the depicted embodiment, shield flange 100A is situated directly opposite tip 82 from shield flange 100B, as described in greater detail below with respect to FIG. 6. Shield flanges 100A and 100B may be shock absorbing elements that protect tip 82, base 88, and tip assembly face 98 from damage should electrostatic spray gun 12 be dropped.

Shield tower 102 is a substantially cylindrical sleeve that surrounds all but a distal end of electrode 54 when spray tip assembly 34 is secured in place on gun barrel 30. Shield tower 102 leaves 0.045 inches (1.143 mm) at the distal end of electrode 54 exposed to ionize atomized fluid via a corona current. Shield tower 102 controls the source of corona discharge for atomizing fluid. In the depicted embodiment, shield tower 102 is asymmetrically situated with respect to tip 82 and shield flanges 100A and 100B, and partially overlaps with shield flange 100B. A raised tip such as tip 82 is less prone to fouling than a recessed tip, and a single asymmetrically situated electrode such as electrode 54 is more efficient at ionizing fluid particles than multi-electrode systems. A raised spray orifice 87 can, however, give rise to increased discharge energy if a grounded object is brought near air cap 84 such that tip 82 is situated between electrode 54 and the grounded objection. Some spray guns avoid high energy discharges by positioning multiple electrodes around a spray tip, such that an electrode is always positioned between the spray tip and a grounded objection, but the repelling nature of like electrodes also hinders efficient charging of paint exiting the fluid orifice 87. Shield tower 102 protects against high energy discharges by raising the location of the corona discharge from electrode 5 and keeping it away from spray tip 82 as any grounded object approaches, and does not negatively impact ionization efficiency.

FIG. 6 is a head-on view of spray tip assembly 34, illustrating tip 82 (with fluid orifice 87), base piece 88 (with ports 52A and 52B), and shield piece 90 (with shield tower 102, and shield flanges 100A and 100B each having broad base 106 and wedge section 108). FIG. 6 shows angular locations F_{A} and F_{B} of shield flanges 100A and 100B, respectively, and angular location T of shield tower 102. Angular locations F_{A} and F_{B} are offset by Θ_{A} and Θ_{B}, respectively, relative to a common 0° reference line (as shown). Angular location T is offset by Θ_{A} relative to the 0° reference line. In the depicted embodiment, |Θ_{A}|=|Θ_{B}|=90°, such that shield flange 100A is immediately opposite tip 82 from shield flange 100B. Experimental tests have shown that this position of shield flanges 100A and 100B protects against arcing from electrode 54 through tip 82. In other embodiments, shield flanges 100A and 100B may be offset by different angles (i.e. |Θ_{A}|≠|Θ_{B}|, or may be offset by the same amount, but not directly opposite each other (i.e. |Θ_{A}|=|Θ_{B}|≠90°. Angular location T is offset by Θ_{A} relative to the 0° reference line, and accordingly offset by Θ_{TF} relative to angular location F_{B} of shield flange 100B, such that Θ_{T}=Θ_{FB}−Θ_{TF}. In some embodiments, Θ_{TF} may for instance be between 32° and 42°. More generally, shield tower 102 and electrode 54 break the 180° rotational symmetry of spray tip assembly 34.

As discussed above with respect to FIG. 4, tip 82 is raised relative to tip assembly face 98 to reduce fouling of fluid orifice 87, and improve spray efficiency. Electrode 54 ionizes atomized fluid from fluid orifice 87 with greater efficiency than paired symmetric electrodes. Shield flanges 100A and 100B and shield tower 102 cooperate to prevent arcing between electrode 54 and tip 82, which would otherwise be likely to occur due to the asymmetric position of electrode 54 and the raised position of tip 82.

Although the present invention has been described with reference to preferred embodiments, workers skilled in the art will recognize that changes may be made in form and detail without departing from the spirit and scope of the invention.

1. An electrostatic spray gun comprises:
a gun barrel;
a gun handle affixed to the gun barrel; and
a spray tip assembly affixed to the gun barrel, the spray tip assembly comprising:
a tip assembly face;
a tip disposed at the tip assembly face;
an electrode extending perpendicularly from the tip assembly face;
a shield tower extending perpendicularly from the tip assembly face, and disposed cylindrically about the electrode.

2. The electrostatic spray gun of claim 1, wherein the spray tip assembly comprises:
a base that attaches to the second end of the gun barrel and the electrode;
a shield that attaches to the base piece, and comprises the tip assembly face and the shield tower; and
a tip retained against the elongated gun barrel by the base piece, and comprising the spray tip.

3. The electrostatic spray gun of claim 2, wherein the spray tip assembly further comprises a retainer ring disposed to secure the shield piece and the base piece to the elongated gun barrel.

4. The electrostatic spray gun of claim 2, wherein the shield tower is a substantially cylindrical portion of the shield piece that surrounds all but a distal end of the electrode.

5. The electrostatic spray gun of claim 4, wherein the distal end comprises less than 0.05 inches (1.25 mm) of the electrode.

6. The electrostatic spray gun of claim 1, wherein the spray tip assembly further comprises first and second shield flanges situated on opposite sides of the tip, and extending away from the tip assembly face.

7. The electrostatic spray gun of claim 6, wherein the electrode and the shield tower are disposed asymmetrically with respect to the tip and the first and second shield flanges.

8. The electrostatic spray gun of claim 7, wherein the shield tower is partially built into the first shield flange.

9. The electrostatic spray gun of claim 7, wherein the shield tower is offset from the first shield flange by an angular offset between 32° and 42°.

10. The electrostatic spray gun of claim 1, wherein the tip is raised with respect to the tip assembly face.

11. The electrostatic spray gun of claim 1, further comprising an alternator and a power supply disposed to apply a voltage to the electrode.

12. The electrostatic spray gun of claim 11, further comprising an air system disposed to drive the alternator and propel fluid from the tip.

13. A spray tip assembly of an electrostatic spray gun with a gun barrel, the spray tip assembly comprising:
a base configured to attach to the gun barrel;
an electrode embedded in and extending from the base piece;
a shield that attaches to the base piece, and that comprises a tip assembly face and a shield tower that extends perpendicularly to the tip assembly face to partially surround the electrode; and
a tip disposed in the base piece, and comprising a fluid orifice.

14. The spray tip assembly of claim 13, wherein the shield further comprises first and second shield flanges disposed at opposite sides of the tip.

15. The spray tip assembly of claim 14, wherein the electrode is disposed asymmetrically with respect to the fluid orifice and the first and second shield flanges.

16. The spray tip assembly of claim 14, wherein the shield tower is offset from the first shield flange by an angular offset between 32° and 42°.

17. The spray tip assembly of claim 13, wherein the spray tip assembly further comprises a retainer ring for securing the shield and the base to the barrel of the electrostatic spray gun.

18. The spray tip assembly of claim 13, wherein the base and the shield together comprise an air cap with an air port directing airflow from the body of the electrostatic spray gun in front of the fluid orifice.

19. The spray tip assembly of claim 18, wherein the air cap comprises a plurality of air ports directing airflow from the body of the electrostatic spray gun in front of the fluid orifice.
